(19) United States
(12) Patent Application Publication
(10) Pub. No.: US 2002/0143649 A1
(43) Pub. Date: Oct. 3, 2002

(54) Method of distributing photographs online through a hierarchy

(76) Inventor: Nathan Charles Wise, Gambrills, MD (US)

Correspondence Address: SHOEMAKER AND MATTARE, LTD., Suite 1203, Crystal Plaza Building 1, 2001 Jefferson Davis Highway, Arlington, VA, 22202, US

(21) Appl. No.: 09/925,307

(22) Filed: Aug. 10, 2001

Related U.S. Application Data
(60) Provisional application No. 60/279,418, filed on Mar. 29, 2001.

(51) Int. Cl. G06F 17/60

(52) U.S. Cl. 705/26; 705/27

(57) ABSTRACT

Each digital photo taken by a participating photographer is assigned a unique number which is given to the subject of the photo. The photos are then uploaded to a website where they are stored on a server and made accessible to the subjects of the photos via the internet. The photos preferably are virtually branded with a watermark or proof mark, and are also permanently associated with an ornamental border. Knowing his photo number, the subject can view his photograph online, and e-mail it to others, who can order high quality versions of selected photos online. The web site refers such orders to one or more finishing laboratories that prepare photos and mail them directly to the customers. The web site secures payment for this service by a credit card charge, and then distributes those fees down a marketing hierarchy, ultimately to the photographers, according to a protocol agreed to in advance by all participants.

This application claims priority from provisional patent application No. 60/279418, filed Mar. 29, 2001.

### BACKGROUND OF THE INVENTION

This invention relates to a method of distributing photographs online.

Some businesses allow consumers to download or distribute digital photographs from a server accessible through a wide area network such as the internet. They generate revenues by securing a fee from the subjects of the photographs as a prerequisite to downloading or by distributing selected photos or having them specially processed. The user usually must peruse an array of thumbnail versions of photographs, and to select a thumbnail before being able to view the photograph in a full-screen mode. Examples are found at www.zing.com, www.photoreflect.com, www.shutterfly.com, and www.photopoint.com. Such operations typically require an end user to download special software onto his computer before he can use the system.

To our knowledge, current photo distribution systems do not provide an accounting system for automatically distributing profits between levels in a distribution hierarchy.

### SUMMARY OF THE INVENTION

An object of the invention is to enable photographers to upload digital photographs to a site on the internet without having first to download special software from the site.

Another object of the invention is to provide a numbering scheme which uniquely identifies each set of photographs uploaded to it by photographers number and set number, and to assign each photograph in the set a unique frame number.

A further object of the invention is to enable the photographer to select a virtual picture border for each set of photos as they are uploaded.

Another object is to give the subjects of photos the ability to quickly find, view and download their photos on the internet site, without requiring the use of special software.

Yet another object of the invention is to distribute fees earned at each download or distribution event between plural levels in a distribution hierarchy.

These and other objects are attained by a method of distributing photographs online as described below.

### BRIEF DESCRIPTION OF THE DRAWINGS

In the accompanying drawings,

FIG. 1 is a diagrammatic representation of a distribution hierarchy in an online photo distributing system.

### DESCRIPTION OF THE PREFERRED EMBODIMENT

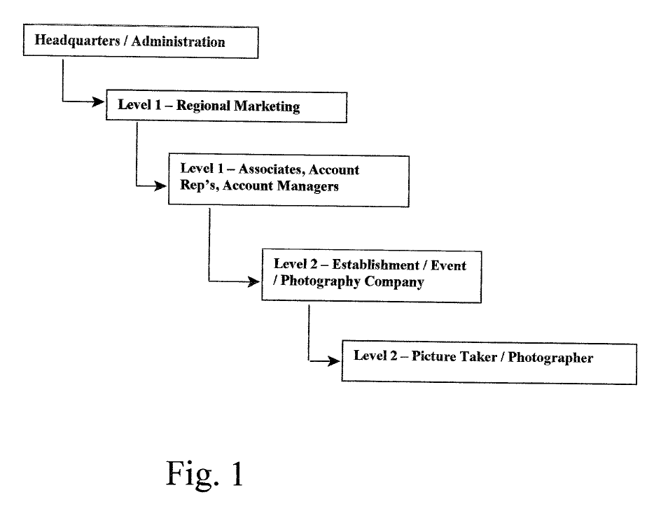

A system embodying the invention is shown in FIG. 1. The top level is a headquarters which administrates the system and maintains a web site. The web site resides on a server which contains applications which automatically supervise photo uploading, downloading, and accounting functions. A portion of the server is reserved for digital photo data.

The marketing tree beneath the headquarters includes a first level comprising a few regional marketing firms, a second level including local associates, account representatives, and account managers, a third level of commercial establishments, special events, and photography companies, and fourth level comprising photographers and other picture takers. For the sake of simplicity, we use the term “photographer” herein to connote anyone who takes a photo, not just professional photographers. Each level in the hierarchy recruits members of the next lower level, securing an agreement to abide by various terms such as the distribution protocol discussed in the next paragraph. The website maintains a database identifying all entities at all levels, so that it can know how to attribute orders for photos from a particular photographer. All entities in the marketing tree are granted special access to view the system's records of their own sales and commissions, and those of entities below them on the tree.

It should be understood that the levels described above are merely exemplary and that this invention is broadly applicable to a system having any plural number of marketing levels.

The entities at each level have discretion on how to allot service fees which come to them from the level above. For example, a regional office may choose to allot itself one-third of revenues, and distribute two-thirds to its subsidiary offices on a uniform basis. Or it may discriminate between its subsidiary offices, granting one a greater percentage than another. Any number of motivating plans are possible. However, local discretion is not absolute.

The headquarters limits the discretion of the subsidiary offices by establishing a fee distribution protocol specifying, for each level, or for each entity, in the distribution tree:

(1) a business use percentage, which is the portion of the value of a transaction which each entity at a given level can receive for itself and for distribution to lower levels, and

(2) a maximum payout percentage, which is the greatest portion of the value of a transaction which any entity can keep for itself. The protocol also identifies

(3) which items in a transaction are exempt from distribution to other levels. For example, shipping and handling fees may not be distributable items.

The headquarters maintains a database and numbering scheme which identifies each photographer by number, and in addition the identity of each higher entity in the system, and the payout percentage each is to receive.

The site also maintains, in addition to the fee distribution database, a database or file system for storing each set of photos on the server, as well as the code, the city, the location and date of the photograph, and an indicator of the virtual borders selected by the photographers.

In operation of the system, a photographer takes a digital photo of a subject, and hands the subject a card or the like containing a photo ID number. The number has a prescribed format, such as 111-111-111-D1234-P123, where the first nine digits identify the photographer, the next group of digits a particular “roll” or set of pictures, and the final group identify the particular picture or frame within the set.

At day's end, for example, the photographer or an assistant uploads his day's work to the site. This is done simply by connecting the camera (or a removable media player) to a local internet-connected personal computer, and using software provided by the camera manufacturer to upload the contents of the camera to the server at the site. No special software need be downloaded for this activity. While uploading, the photographer or uploader may specify a particular virtual border for association with the photographs of the set. The web site maintains a library of border designs which can be selected from. Optionally, some or all of the borders may be locally customizable, for example by adding text such as the name of the photographer or event associated with the photo.

After his photograph has been uploaded into the system, the subject of the photo can now log onto the site and, using the ID number provided by the photographer, view without charge his photograph(s). Each photograph at this point is overlaid with a watermark or proof mark, or like imperfection. The proof mark may be subtle so that the composition can be adequately evaluated online. High quality, unmarked versions of the photos may be ordered online from a laboratory. We currently prefer that the virtual borders previously specified by the photographer not be removable.

The user may download or distribute (e-mail) the proofs to friends and family. The subject, or those to whom he has e-mailed proofs, may order selected photos from the web site, providing a mailing address and a credit card number when placing the order. Orders may be sent automatically by the website to a finishing laboratory, or the lab may periodically download new orders from the web site. The lab then mails the finished photos directly to the person who placed the order. The web site secures payment for the photos at that time by processing a credit card transaction.

The website, on a continuous or regular periodic basis, calculates the fees it has received, and the percentage each level below it is entitled to, based on the previously established protocol. Beginning with the website, each level retains a portion of the fees its photographers have generated, and the remainder is distributed to the next lower level, ultimately to the photographers around the world whose uploaded photos were subsequently ordered. The mechanics of payment may vary. For example, each entity may actually make payments only to those entities directly below it in the chain of command, or all payments may be made from the headquarters to all entities within the tree.

Since the invention is subject to modifications and variations, it is intended that the foregoing description and the accompanying drawings shall be interpreted as only illustrative of the invention defined by the following claims.

I claim:

1. In a method of distributing digital photographs over the internet involving steps of taking a photograph, assigning an ID number to the photograph, uploading the photograph and ID number to a web site, making the photograph, with a proof mark, available for viewing on the web site, and facilitating online ordering of the photograph without the proof mark from a laboratory, the improvement comprising a step of pre-selecting a virtual border for association with the photograph when viewed online.

2. In a method of distributing digital photographs over the internet involving steps of taking a photograph, assigning an ID number to the photograph, uploading the photograph and ID number to a web site, making the photograph, with a proof mark, available for viewing on the web site, and facilitating online ordering of the photograph without the proof mark from a laboratory for a service fee, the improvement comprising steps of
establishing a plural-level marketing hierarchy, and
establishing and enforcing a fee distribution protocol for distributing service fees down through the hierarchy.

3. The method of claim 2, wherein said protocol includes, for each level, a specified maximum portion of the service fee that each level can use for its level and lower levels.

4. The method of claim 2, wherein said protocol includes, for each level, a maximum percentage of the service fee that that level can retain for itself.

5. The method of claim 2, further comprising a step of distributing service fees collected from consumers among each level in the hierarchy, down to photographers who created the photos.
